(19) United States
(12) Patent Application Publication
(10) Pub. No.: US 2023/0045224 A1
(43) Pub. Date: Feb. 9, 2023

(54) INTELLIGENCE ADAPTATION RECOMMENDATION METHOD BASED ON MCM MODEL

(71) Applicant: SHANGHAI SQUIRREL CLASSROOM ARTIFICIAL INTELLIGENCE TECHNOLOGY CO., LTD., Shanghai (CN)

(72) Inventors: Haoyang LI, Shanghai (CN); Zhaohui XU, Shanghai (CN)

(21) Appl. No.: 17/594,692

(22) PCT Filed: Mar. 24, 2021
(86) PCT No.: PCT/CN2021/082597

§ 371 Date: Oct. 26, 2021

(30) Foreign Application Priority Data
Mar. 31, 2020 (CN) 202010241442.0

(51) Int. Cl. G09B 19/00; G09B 7/08

(52) U.S. Cl. CPC G09B 19/00; G09B 7/08

(57) ABSTRACT

An intelligent adaptive recommendation method based on an MCM model. The method includes acquiring historical data of errors on knowledge points of all students, acquiring error-cause labels of current student, calculating error-cause priority value P(E) for each error-cause label of current student, and extracting, according to at least one of MCM labels corresponding to each error-cause label, MCM learning resources corresponding to at least one of MCM labels from a preset content management system, sorting error-cause labels according to descending order of error-cause priority value P(E), extracting part or all of MCM learning resources from MCM learning resources corresponding to at least one error-cause label according to sorting result and pushing part or all of MCM learning resources to current student, and when current student finishes learning MCM learning resources corresponding to each MCM label, pushing errors on knowledge points corresponding to each MCM label to current student.

The present application claims priority to Chinese Patent Application No. 202010241442.0 filed Mar. 31, 2020 with the CNIPA, the content of which is incorporated herein by reference in its entirety.

### TECHNICAL FIELD

The present application relates to the field of online education technologies, in particular, to an intelligent adaptive recommendation method based on a model of thinking-capacity-methodology (MCM) model.

### BACKGROUND

An MCM is a strategy that splits each learning and thinking to obtain a model of thinking, a capacity of learning and a methodology of learning of a student.

A pushing method of errors prone on knowledge points or learning questions on knowledge points merely determines weakness of students corresponding to knowledge points from answers (false/true) to questions in exams, however real causes of errors on knowledge points are not considered. The errors on knowledge points may be caused by problems existed in a deeper level such as the model of thinking, the capacity of learning and the methodology of learning, and may be caused by other problems existed in non-intellectual factors such as psychological factors or answering habits of the students, in addition to the errors on knowledge points are caused by contents on knowledge points not mastered.

The above pushing method results in low learning efficiency, and merely cure the symptoms rather than the cause in improving learning, which is difficult for students to improve their learning substantially.

### SUMMARY

The present application provides an intelligent adaptive recommendation method based on an MCM model to solve the problems that the symptoms rather than the cause are cured in improving learning, and it is difficult for students to improve their learning substantially. An intelligent adaptive recommendation method based on an MCM model is provided and includes steps described below.

Historical data of errors on knowledge points of all students is acquired, where historical data of errors on knowledge points of a student includes data of errors on a plurality of knowledge points, and data of errors on a knowledge point includes errors on a knowledge point, an error-cause label corresponding to the errors on the knowledge point and an MCM label corresponding to the errors on the knowledge point.

A plurality of error-cause labels of a current student are acquired, and at least one first error-cause label is screened out from the plurality of error-cause labels, where the first error-cause is an intelligence factor.

An error-cause priority value P(E) is calculated for each first error-cause label of the at least one first error-cause label of the current student:

$$P ( E ) = P ( H ) + P ( M ) ; \\ P ( H ) = \frac{EH ( S , E )}{EH ( S )} ⨯ \frac{EH ( E )}{{EH ( S )}^{′}} ⨯ N ( t ) ⨯ P ( B ) ; \\ P ( M ) = \frac{EM ( S , E )}{EM ( S )} ;$$

where, EH(S,E) denotes the total number of current error-cause labels of the current student labeled by a user, EHS denotes the total number of all error-cause labels of the current student labeled by a user, EH(E) denotes the total number of error-cause labels of the all students labeled by a user, EH(S) denotes the total number of students having the current error-cause labels labeled by a user, N(t) is a time decay function, N(t)=N₀e−^{kt} , t is the number of days elapsed from a time point when an error-cause label was labeled by a user to a current time point, N₀ and −k are constants, P(B) denotes the number of times that a user labels error-cause labels, EM(S,E) denotes the total number of current error-cause labels of the current student labeled by a machine, and EM(S) denotes the total number of all error-cause labels of the current student labeled by a machine.

MCM learning resources corresponding to the at least one of MCM labels are extracted from a preset content management system according to at least one of MCM labels corresponding to the each of the at least one first error-cause label, the at least one first error-cause label is sorted according to a descending order of the error-cause priority value P(E), part or all of MCM learning resources are extracted from MCM learning resources corresponding to the at least one first error-cause label according to a sorting result and the part or all of the MCM learning resources are pushed to the current student, and in a case where the current student finishes learning MCM learning resources corresponding to each of the at least one of MCM labels, errors on knowledge points corresponding to each of the MCM labels are pushed to the current student.

An MCM is a strategy that splits learning and thinking of students to obtain a model of thinking, a capacity of learning and a methodology of learning of the students.

### BRIEF DESCRIPTION OF DRAWINGS

FIG. 1 is a flowchart of an intelligent adaptive recommendation method based on an MCM model according to an embodiment of the present application.

### DETAILED DESCRIPTION

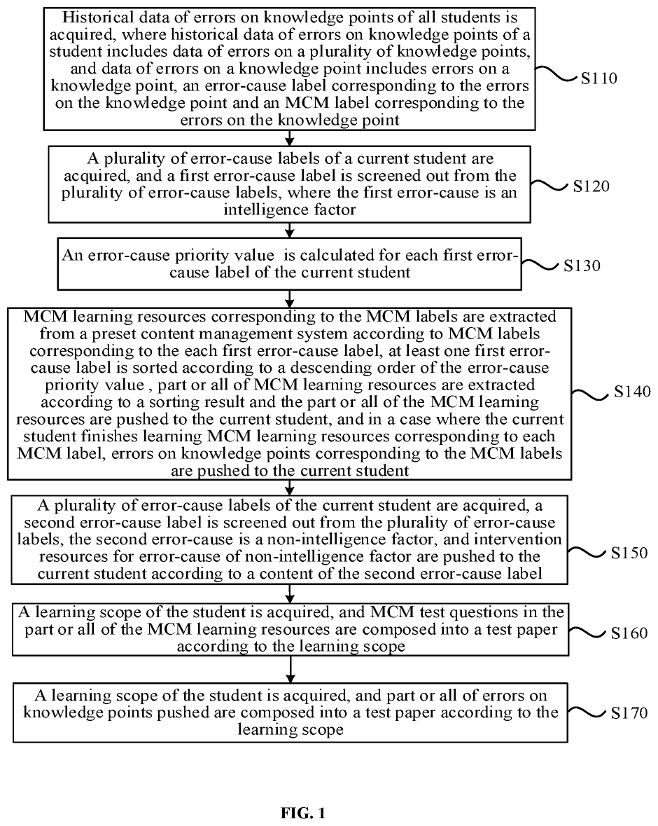

As shown in FIG. 1, an intelligent adaptive recommendation method based on an MCM model includes steps described below.

In step S110, historical data of errors on knowledge points of all students is acquired, where historical data of errors on knowledge points of a student includes data of errors on a plurality of knowledge points, and data of errors on a knowledge point includes errors on a knowledge point, an error-cause label corresponding to the errors on the knowledge point and an MCM label corresponding to the errors on the knowledge point.

In a content management system, test questions and MCM labels are pre-bound. When a student gives a false answer to a test question, an error-cause label is labeled for an error on a knowledge point. Errors on knowledge points, error-cause labels corresponding to the errors on the knowledge points and MCM labels corresponding to the errors on the knowledge points constitute data of the errors on the knowledge points. The error-cause labels are labels reflecting the error-cause in a case where the student gives a false answer to a test question, and the error-cause labels including labels labeled by a user (labeled by the student or an instructor) and labels labeled by a machine (based on a preset rule or a machine learning algorithm). For example, the error-cause labels and error-cause codes are shown in Table 1.

TABLE 1

| Error-cause label | Error-cause code |
|---|---|
| Exhausting | M1000 |
| Boring | M1001 |
| Tensing | M1002 |
| Bad habits in answering-questions | M1003 |
| Sentence pattern being unclear | I1004 |
| Sentence constituents analyzed unclearly | I1005 |
| Lack of accurate understanding for mathematical | I1006 |
| concepts or basic mathematical facts | |
| Formulas not remembered clearly | I1007 |
| physical quantity information unable to be extracted | I1008 |

In the error-cause codes, error-cause codes with a beginning of M represent error-cause labels of non-intelligence factors, and error-cause codes with a beginning of I represent error-cause labels of intelligence factors.

The MCM labels reflect a model of thinking, a capacity of learning and a methodology of learning required to learn knowledge points associated with test questions. For example, the MCM labels used for labeling each test question corresponding to each knowledge point in mathematics, physics or chemistry are shown in Table 2.

TABLE 2

| Common MCM labels among | | |
|---|---|---|
| mathematics, physics and | Common MCM labels in | Specifical MCM labels in |
| chemistry | physics and chemistry | chemistry |
| Capacity for observations | Capacity for applying | Capacity for designing |
| | formula variations | material transformation |
| | | relationships |
| Capacity for conjectures | Capacity for drawing | Capacity for applying |
| | | chemistry rules |
| Capacity for investigations | Capacity for qualitatively | Capacity for learning |
| | analyzing of physical | |
| | quantity | |
| Capacity for deductions | Capacity for designing | Capacity for deducing |
| | experimental schemes | experimental processes |
| Capacity for acquiring effective | Capacity for operating | Capacity for understanding |
| information | experiments | Chemistry rules |
| Capacity for expressing | Capacity for emphasizing | Capacity for associating |
| | main contradictions | cross-subject knowledge |
| Capacity for processing data | Capacity for memorizing | |
| Capacity for spatial imagination | Capacity for concentrating | |
| Capacity for calculation | | |
| Capacity for applying chemistry | | |
| rules | | |
| Capacity for synthesizing | | |

In step S120, a plurality of error-cause labels of a current student are acquired, and a first error-cause label is screened out from the plurality of error-cause labels, where the first error-cause is an intelligence factor.

In step S130, an error-cause priority value P(E) is calculated for each first error-cause label of the current student:

$$P ( E ) = P ( H ) + P ( M ) ; \\ P ( H ) = \frac{EH ( S , E )}{EH ( S )} ⨯ \frac{EH ( E )}{{EH ( S )}^{′}} ⨯ N ( t ) ⨯ P ( B ) ;$$

where EH(S,E) denotes the total number of current error-cause labels of the current student labeled by a user, EH(S)′ denotes the total number of all error-cause labels of the current student labeled by a user, EH(E) denotes the total number of error-cause labels of the all students labeled by a user, EH(S) denotes the total number of students having the current error-cause labels labeled by a user, N(t) is a time decay function, N(T)=N₀e^{-kt} , t is the number of days elapsed from a time point when an error-cause label was labeled by a user to a current time point, N₀ and −k are constants, and P(B) denotes the number of times that a user labels error-cause labels; and

$$P ( M ) = \frac{EM ( S , E )}{EM ( S )} ;$$

where EM(S, E) denotes the total number of current error-cause labels of the current student labeled by a machine, and EM(S) denotes the total number of all error-cause labels of the current student labeled by a machine.

In this embodiment, when a user labels an error-cause label once, a number of behavior times is added by one, and the number of behavior times that the user labels the error-cause label is counted by day. The more behavior times that the user labels the error-cause label in a day, the greater the influence of the error-cause label on the user. EH(S,E) refers to counting a total number of all the current error-cause labels, and P(B) refers to counting the number of the current error-cause labels for the current student by day. When the error-cause label is labeled once, the number of the error-cause is added by one.

In step S140, MCM learning resources corresponding to the MCM labels are extracted from a preset content management system according to MCM labels corresponding to the each first error-cause label, at least one first error-cause label is sorted according to a descending order of the error-cause priority value P(E), part or all of MCM learning resources are extracted according to a sorting result and the part or all of the MCM learning resources are pushed to the current student, and in a case where the current student finishes learning MCM learning resources corresponding to each MCM label, errors on knowledge points corresponding to the MCM labels are pushed to the current student.

The MCM learning resources include videos, teaching materials, MCM test questions and the like. Contents of the videos, contents of the teaching materials and contents of the MCM test questions may apply to a plurality of subjects. For example, when the MCM label is a capacity for observation, there are many subjects involving the capacity for observation. In order to improve a capacity for observation of a student, the contents of the videos, the contents of the teaching materials and the contents of the MCM test questions in learning resources will tutor the student how to consciously perceive numeral characteristics of an object and shape characteristics of an object, that is, to observe characteristics of mathematical relationships, propositions and geometric figures expressed by symbols, letters, numbers or words, and will tutor the student to perform a continuous observation, a comprehensive observation, or a comparative observation for an physical phenomena, and then will use MCM test questions to examine whether the student has mastered the capacity for observation tutored.

A plurality of errors on knowledge points corresponding to the MCM label are pushed to the student, and a plurality of test questions on knowledge points may correspond to a same knowledge point or a plurality of different knowledge points.

In this embodiment, one error-cause label corresponds to one or more MCM labels, and one MCM label corresponds to one or more errors on knowledge points. An error-cause priority value P(E) is calculated for the error-cause label, so that the student first learns MCM learning resources corresponding to a plurality of MCM labels corresponding to an error-cause label with a high error-cause priority value P(E), and then learns a plurality of errors on knowledge points corresponding to each MCM label, thereby enabling the student first to learn for one error-cause label from an aspect of a model of thinking, an ability of learning and a methodology of learning, and then to learn the plurality of errors on knowledge points corresponding to the MCM label, which can achieve half the work with double results, and solve the problems that the symptoms rather than the cause are cured in improving learning, and it is difficult for students to improve their learning substantially.

In this embodiment, when the errors on the knowledge points corresponding to the MCM label are pushed to the student, the method further includes extended errors on knowledge points are extracted and the extended errors on knowledge points are pushed to the current student, which includes steps described below.

In step A, n answer results {0,1} of n historical errors on knowledge points of the current student are acquired, where a true answer is labeled as 0, a false answer is labeled as 1, and the n answer results of the n historical errors on knowledge points of the current student are collected as a set A.

In step B, n answer results {0,1} of n historical errors on knowledge points of another student are acquired, where a true answer is labeled as 0, a false answer is labeled as 1, and the n answer results of the n historical errors on knowledge points of the another student are collected as a set B, where error-cause labels of the another student corresponding to the n historical errors on knowledge points are same as error-cause labels of the current student corresponding to the n historical errors on knowledge points.

In step C, a similarity between the current student and the another student is calculated according to

$$J ( A , B ) = \frac{\vert A∩B \vert}{\vert A ⋃ B \vert} = \frac{\vert A∩B \vert}{\vert A \vert + \vert B \vert - \vert A∩B \vert} ,$$

0≤J(A, B)≤1 where when A and B both are null, J(A, B)=1

In step D, step B and step C are executed repeatedly, until similarities between all other students and the current student have been calculated.

In step E, a student having a highest similarity with the current student is determined, a plurality of errors on knowledge points of the student having the highest similarity excluding the n historical errors on knowledge points are retrieved, and the plurality of errors on knowledge points retrieved are pushed to the current student as the extended errors on knowledge points.

For example, as shown in Table 3, if there are four students in total, a first student is the current student, the number of historical errors on knowledge points n satisfying n=4, and two comparison objects A and B are given. Both A and B have four binary attributes, that is, a value of each attribute is {0, 1}, a true answer is labeled as 0, and a false answer is labeled as 1. According to the similarity calculation formula, it is concluded that Student 1 and Student 4 have the highest similarity, so Question 5 will be recommended to Student 1.

TABLE 3

| Student | Question 1 | Question 2 | Question 3 | Question 4 | Question 5 |
|---|---|---|---|---|---|
| Student 1 | 1 | 1 | 1 | 1 | 0 |
| Student 2 | 1 | 0 | 1 | 0 | 1 |
| Student 3 | 0 | 1 | 1 | 0 | 1 |
| Student 4 | 1 | 1 | 1 | 1 | 1 |

In this embodiment, step S130 further includes calculating an error-cause priority value P(E) for each of a plurality of error-cause labels of the current student, sorting the plurality of error-cause labels according to a descending order of the error-cause priority values P(E), and pushing a sorting result to the current student. By pushing the entire sorting result to the current student, the current student can clearly know that which error-causes are intelligence factors and which error-causes are non-intelligence factors, and priority values of those error-causes.

The method further includes step S150 in which a plurality of error-cause labels of the current student are acquired, a second error-cause label is screened out from the plurality of error-cause labels, the second error-cause is a non-intelligence factor, and intervention resources for error-cause of non-intelligence factor are pushed to the current student according to a content of the second error-cause label.

In this embodiment, the method further includes step S160 in which a learning scope of the student is acquired, and MCM test questions in the part or all of the MCM learning resources are composed into a test paper according to the learning scope.

In this embodiment, the method further includes step S170 in which a learning scope of the student is acquired, and part or all of errors on knowledge points pushed are composed into a test paper according to the learning scope.

The learning scope includes at least one of information of learning subjects, an estimated learning duration or a type of question learned.

In this application, the error-cause priority value is used to sort, which can effectively find significant weakness of students and provide references for eliminating the weakness of students.

In this application, error-cause labels of an intelligence factor are screened out from error-cause labels corresponding to the knowledge points, thus a targeted learning may be applied for the students, and questions with false answers labeled as error-cause labels of a non-intelligence factor do not need to be learned repeatedly, thereby improving the learning efficiency. Further, in this application, MCM labels bounded to the errors on knowledge points in historical data of errors on knowledge points are acquired, MCM learning resources are pushed to the student according to the MCM labels, and in a case where the student finishes learning the MCM learning resources, errors on knowledge points corresponding to the MCM labels are pushed to the student. In such a way, the student first learns from an aspect of a mode of thinking, an ability of learning and a methodology of learning, and then learns the errors on knowledge points, which can achieve half the work with double results, and solve the problems that the symptoms rather than the cause are cured in improving learning, and it is difficult for students to improve their learning substantially.

1. An intelligent adaptive recommendation method based on a model of thinking-capacity-methodology (MCM) model, comprising:
acquiring historical data of errors on knowledge points of all students, wherein historical data of errors on knowledge points of a student comprises data of errors on a plurality of knowledge points, and data of errors on a knowledge point comprises errors on a knowledge point, an error-cause label corresponding to the errors on the knowledge point, and an MCM label corresponding to the errors on the knowledge point;
acquiring a plurality of error-cause labels of a current student, and screening out first error-cause labels from the plurality of error-cause labels, the first error-cause being an intelligence factor;
calculating an error-cause priority value P(E) for each first error-cause label of the first error-cause label of the current student:
$$P ( E ) = P ( H ) + P ( M ) ; \\ P ( H ) = \frac{EH ( S , E )}{E H ( S )} ⨯ \frac{E H ( E )}{E {H ( S )}^{′}} ⨯ N ( t ) ⨯ P ( B ) ; \\ P ( M ) = \frac{EM ( S , E )}{EM ( S )} ;$$
Wherein, EH(S,E)denotes a total number of current error-cause labels of the current student labeled by a user, EH(S)′ denotes a total number of all error-cause labels of the current student labeled by a user, EH(E) denotes a total number of error-cause labels ofthe all students labeled by a user, EH(S) denotes a total number of students having the current error-cause labels labeled by a user, N(t) is a time decay function, N(t)=N₀e−^{kt}, t is a number of days elapsed from a time point when an error-cause label was labeled by a user to a current time point, N₀ and −k are constants, P(B) denotes a number of times that a user labels error-cause labels, EM(S,E) denotes a total number of current error-cause labels of the current student labeled by a machine, and EM) denotes a total number of all error-cause labels of the current student labeled by a machine; and extracting, according to MCM labels corresponding to the each of the first error-cause labels, MCM learning resources corresponding to the MCM labels from a preset content management system, sorting the first error-cause labels according to a descending order of the error-cause priority value P(E), extracting part or all of MCM learning resources from MCM learning resources corresponding to the first error-cause labels according to a sorting result and pushing the part or all of the MCM learning resources to the current student, and in a case where the current student finishes learning MCM learning resources corresponding to each of the MCM labels, pushing errors on knowledge points corresponding to each of the MCM labels to the current student;
wherein an MCM is a strategy that splits learning and thinking of students to obtain a model of thinking, a capacity of learning and a methodology of learning of the students.

2. The method of claim 1, further comprising:
in a case of pushing the errors on knowledge points corresponding to the each of the MCM labels to the current student, extracting extended errors on knowledge points and pushing the extended errors on knowledge points to the current student;
wherein extracting the extended errors on knowledge points and pushing the extended errors on knowledge points to the current student comprises:
Step-A, acquiring an answer result {0,1} of each historical error on knowledge points of n historical errors on knowledge points of the current student, wherein a true answer is labeled as 0, a false answer is labeled as 1, and collecting n answer results of the n historical errors on knowledge points of the current student as a set A;
Step-B, acquiring n answer results {0,1} of n historical errors on knowledge points of a next student, wherein a true answer is labeled as 0, a false answer is labeled as 1, and collecting the n answer results of the n historical errors on knowledge points of the next student acquired as a set B; wherein error-cause labels of the next student corresponding to the n historical errors on knowledge points are same as error-cause labels of the current student corresponding to the n historical errors on knowledge points;
Step-C, calculating a similarity between the current student and the next student according to
$$J ( A , B ) = \frac{\vert A∩B \vert}{\vert A ⋃ B \vert} = \frac{\vert A∩B \vert}{\vert A \vert + \vert B \vert - \vert A∩B \vert} ,$$
0≤J(A,B)≤1, wherein in a case where A and B both are null, J(A,B)=1;
Step-D, acquiring n answer results {0,1} of n historical errors on knowledge points of a next student, wherein a true answer is labeled as 0, a false answer is labeled as 1, collecting, the n answer results of the n historical errors on knowledge points of the next student acquired as a set B: and entering Step-C: wherein error-cause labels of the another next student corresponding to the n historical errors on knowledge points are same as error-cause labels of the current student corresponding to the n historical errors on knowledge points:
Step-E, executing the Step-D until similarities between all students having same error-cause labels corresponding to n historical errors on knowledge points as the current student and the current student have been calculated; and
determining a student having a highest similarity with the current student, retrieving a plurality of errors on knowledge points of the student having the highest similarity excluding the n historical errors on knowledge points, and pushing the plurality of errors on knowledge points as the extended errors on knowledge points to the current student.

3. The method of claim 1, further comprising:
calculating error-cause priority values P(E) for a plurality of error-cause labels of the current student, sorting the plurality of error-cause labels according to a descending order of the error-cause priority values P(E), and pushing a sorting result to the current student.

4. The method of claim 1, further comprising:
acquiring a learning scope of the current student, and composing MCM test questions in the part or all of the MCM learning resources pushed into a test paper according to the learning scope.

5. The method of claim 1, further comprising:
acquiring a learning scope of the current student, retrieving, according to the learning scope, at least one MCM label corresponding to data of errors on at least one knowledge point, and composing part or all of errors on knowledge points pushed corresponding to each MCM label of the at least one MCM labels retrieved into a test paper.

6. The method of claim 1, further comprising:
acquiring a plurality of error-cause labels of the current student, screening out a second error-cause label from the plurality of error-cause labels, the second error-cause being a non-intelligence factor, and pushing intervention resources for error-cause of non-intelligence factor to the current student according to a content of the second error-cause label.
